(19) United States
(12) Patent Application Publication
(10) Pub. No.: US 2024/0281721 A1
(43) Pub. Date: Aug. 22, 2024

(54) METHOD AND SYSTEM FOR COMPUTING UNSTABILITY FACTORS IN PREDICTIVE MODEL

(71) Applicant: JPMorgan Chase Bank, N.A., New York, NY (US)

(72) Inventors: Saumitra MISHRA, London (GB); Freddy LECUE, Mamaroneck, NY (US); Cecilia TILLI, London (GB); Daniele MAGAZZENI, London (GB); Sanghamitra DUTTA, New York, NY (US); Jason LONG, Cambridge (GB)

(73) Assignee: JPMorgan Chase Bank, N.A., New York, NY (US)

(21) Appl. No.: 18/112,272

(22) Filed: Feb. 21, 2023

(51) Int. Cl. G06N 20/20; G06Q 40/04

(52) U.S. Cl. CPC G06N 20/20; G06Q 40/04

(57) ABSTRACT

Methods and systems for generating a counterfactual explanation that is robust with respect to a machine learning model and changes in the model are provided. The method includes: receiving raw data and training a model by using the raw data; perturbing the model by modifying the raw data; computing a first counterfactual explanation that relates to the model; computing a first counterfactual stability metric that relates to the original version of the first model and a second counterfactual stability metric that relates to the perturbed version of the first model; retrieving unstable counterfactual factors that relates to original and perturbed versions of the model; deleting data points that include any such unstable counterfactual factor; and reconstructing the model based on data that does not include the deleted data points.

### BACKGROUND

### 1. Field of the Disclosure

This technology generally relates to methods and systems for computing unstability factors in a machine learning model, and more particularly to methods and systems for generating a counterfactual explanation that is robust with respect to a machine learning model and changes in the model.

### 2. Background Information

Counterfactual explanations have generated immense interest in several high-stakes applications, such as, for example, lending, credit decisions, and hiring. Broadly speaking, the goal of counterfactual explanations is to guide an applicant on how they can change the outcome of a model by providing suggestions for improvement. Given a specific input value (e.g., a data point that is declined by a model), counterfactual explanations attempt to find another input value for which the model would provide a different outcome, i.e., essentially get accepted. Such an input value that changes the model outcome is often referred to as a counterfactual.

Previous works have generally focused on finding counterfactuals that are as “close” to the original data point as possible with respect to various distance metrics, e.g., L₁ cost or L₂ cost. This cost is believed to represent the “effort” that an applicant might need to make to get accepted by the model. Thus, the “closest” counterfactuals essentially represent the counterfactuals attainable with minimum effort.

However, the closest counterfactuals may not always be the most preferred ones. For instance, if the model changes even slightly, e.g., due to retraining, the counterfactual may no longer remain valid. In particular, it may be shown that a large fraction of the “closest” counterfactuals generated using the state-of-the-art techniques for tree-based models no longer remain valid. This motivates a primary question: How does one generate counterfactuals for tree-based ensembles that are not only close but also robust to changes in the model?

Accordingly, there is a need for a method for generating a counterfactual explanation that is robust with respect to a machine learning model and changes in the model.

### SUMMARY

The present disclosure, through one or more of its various aspects, embodiments, and/or specific features or sub-components, provides, inter alia, various systems, servers, devices, methods, media, programs, and platforms for methods and systems for generating a counterfactual explanation that is robust with respect to a machine learning model and changes in the model.

According to an aspect of the present disclosure, a method for generating a counterfactual explanation that is robust with respect to a machine learning model and changes in the model is provided. The method is implemented by at least one processor. The method includes: receiving, by the at least one processor, a first set of raw data that is usable for training an original version of a first model; training, by the at least one processor, the original version of the first model by using the first set of raw data; perturbing, by the at least one processor, the first model by modifying the first set of raw data, in order to generate a perturbed version of the first model; computing, by the at least one processor, a first counterfactual explanation that relates to the first model; computing, by the at least one processor, a first counterfactual stability metric that relates to the original version of the first model and a second counterfactual stability metric that relates to the perturbed version of the first model; identifying, by the at least one processor, at least one unstable counterfactual factor that relates to at least one from among the original version of the first model and the perturbed version of the first model; deleting, by the at least one processor, data points that include the at least one unstable counterfactual factor from each of the original version of the first model and the perturbed version of the first model; and reconstructing each of the original version of the first model and the perturbed version of the first model based on data that does not include the deleted data points.

The perturbing of the first model may include at least one from among introducing at least one additional data point to the first set of raw data, deleting at least one data point from the first set of raw data, averaging a plurality of data points of a subset of the first set of raw data, and weighting at least one data point from the first set of raw data.

The first counterfactual explanation may include a first plurality of features that relate to the first model and, for each respective feature from among the first plurality of features, a corresponding value.

The computing of the first counterfactual stability metric may include calculating a difference between a mean value of output values of the original version of the first model for a predetermined subset of the first set of raw data and a standard deviation of the output values of the original version of the first model for the predetermined subset of the first set of raw data.

The computing of the second counterfactual stability metric may include calculating a difference between a mean value of output values of the perturbed version of the first model for a predetermined subset of the first set of raw data and a standard deviation of the output values of the perturbed version of the first model for the predetermined subset of the first set of raw data.

The identifying of the at least one unstable counterfactual factor may include identifying a counterfactual factor for which an output of the original version of the first model corresponds to a first prediction and an output of the perturbed version of the first model corresponds to a second prediction that is different from the first prediction.

The first model may include at least one from among a tree-based model, a neural network model, and a linear model.

The first set of raw data may include bond pricing data that relates to a first bond. The first model may be configured to generate a projected price of the first bond at a particular time.

According to another exemplary embodiment, a computing apparatus for generating a counterfactual explanation with respect to a machine learning model is provided. The computing apparatus includes a processor; a memory; and a communication interface coupled to each of the processor and the memory. The processor is configured to: receive, via the communication interface, a first set of raw data that is usable for training an original version of a first model; train the original version of the first model by using the first set of raw data; perturb the first model by modifying the first set of raw data, in order to generate a perturbed version of the first model; compute a first counterfactual explanation that relates to the first model; compute a first counterfactual stability metric that relates to the original version of the first model and a second counterfactual stability metric that relates to the perturbed version of the first model; identify at least one unstable counterfactual factor that relates to at least one from among the original version of the first model and the perturbed version of the first model; delete data points that include the at least one unstable counterfactual factor from each of the original version of the first model and the perturbed version of the first model; and reconstruct each of the original version of the first model and the perturbed version of the first model based on data that does not include the deleted data points.

The processor may be further configured to perturb the first model by at least one from among introducing at least one additional data point to the first set of raw data, deleting at least one data point from the first set of raw data, averaging a plurality of data points of a subset of the first set of raw data, and weighting at least one data point from the first set of raw data.

The first counterfactual explanation may include a first plurality of features that relate to the first model and, for each respective feature from among the first plurality of features, a corresponding value.

The processor may be further configured to compute the first counterfactual stability metric by calculating a difference between a mean value of output values of the first model for a predetermined subset of the first set of raw data and a standard deviation of the output values of the first model for the predetermined subset of the first set of raw data.

The processor may be further configured to compute the second counterfactual stability metric by calculating a difference between a mean value of output values of the perturbed version of the first model for a predetermined subset of the first set of raw data and a standard deviation of the output values of the perturbed version of the first model for the predetermined subset of the first set of raw data.

The processor may be further configured to identify the at least one unstable counterfactual factor by identifying a counterfactual factor for which an output of the original version of the first model corresponds to a first prediction and an output of the perturbed version of the first model corresponds to a second prediction that is different from the first prediction.

The first model may include at least one from among a tree-based model, a neural network model, and a linear model.

The first set of raw data may include bond pricing data that relates to a first bond. The first model may be configured to generate a projected price of the first bond at a particular time.

According to yet another exemplary embodiment, a non-transitory computer readable storage medium storing instructions for generating a counterfactual explanation with respect to a machine learning model is provided. The storage medium includes executable code which, when executed by a processor, causes the processor to: receive a first set of raw data that is usable for training an original version of a first model; train the original version of the first model by using the first set of raw data; perturb the first model by modifying the first set of raw data, in order to generate a perturbed version of the first model; compute a first counterfactual explanation that relates to the first model; compute a first counterfactual stability metric that relates to the original version of the first model and a second counterfactual stability metric that relates to the perturbed version of the first model; identify at least one unstable counterfactual factor that relates to at least one from among the original version of the first model and the perturbed version of the first model; delete data points that include the at least one unstable counterfactual factor from each of the original version of the first model and the perturbed version of the first model; and reconstruct each of the original version of the first model and the perturbed version of the first model based on data that does not include the deleted data points.

When executed by the processor, the executable code may further cause the processor to perturb the first model by at least one from among introducing at least one additional data point to the first set of raw data, deleting at least one data point from the first set of raw data, averaging a plurality of data points of a subset of the first set of raw data, and weighting at least one data point from the first set of raw data.

According to still another aspect of the present disclosure, a method for generating a counterfactual explanation with respect to a first predictive machine learning (ML) model for which all outputs fall in a range of between 0.0 and 1.0 such that when an output is between 0.0 and 0.5, a first prediction is made and when the output is between 0.5 and 1.0, a second prediction is made, is provided. The method is implemented by at least one processor. The method includes: receiving, by the at least one processor, a first set of raw data that is usable for training the first predictive ML model; training, by the at least one processor, the first predictive ML model by using the first set of raw data; identifying a first data point for which the output of the first predictive ML model is between 0.0 and 0.5 and the first prediction is made; generating a first counterfactual data point such that the output of the first predictive ML model is between 0.5 and 1.0 and the second prediction is made; determining a value of a counterfactual stability metric with respect to the first counterfactual data point; comparing the value of the counterfactual stability metric with a predetermined threshold; when the value of the counterfactual stability metric is greater than or equal to the predetermined threshold, determining the first counterfactual data point as being a robust counterfactual explanation with respect to the first predictive ML model; and when the value of the counterfactual stability metric is less than the predetermined threshold, generating a set of conservative counterfactual data points that are included in the first set of raw data for which a corresponding value of the counterfactual stability metric is greater than the predetermined threshold, and using the set of conservative counterfactual data points to generate a second counterfactual data point for which a corresponding value of the counterfactual stability metric is greater than or equal to the predetermined threshold.

The computing of the counterfactual stability metric may include calculating a difference between a mean value of output values of the first model for a predetermined subset of the first set of raw data and a standard deviation of the output values of the first model for the predetermined subset of the first set of raw data.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for generating a counterfactual explanation that is robust with respect to a machine learning model and changes in the model.

FIG. 4 is a flowchart of an exemplary process for implementing a method for generating a counterfactual explanation that is robust with respect to a machine learning model and changes in the model.

FIG. 5 is a flowchart of another exemplary process for implementing a method for generating a counterfactual explanation that is robust with respect to a machine learning model and changes in the model.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

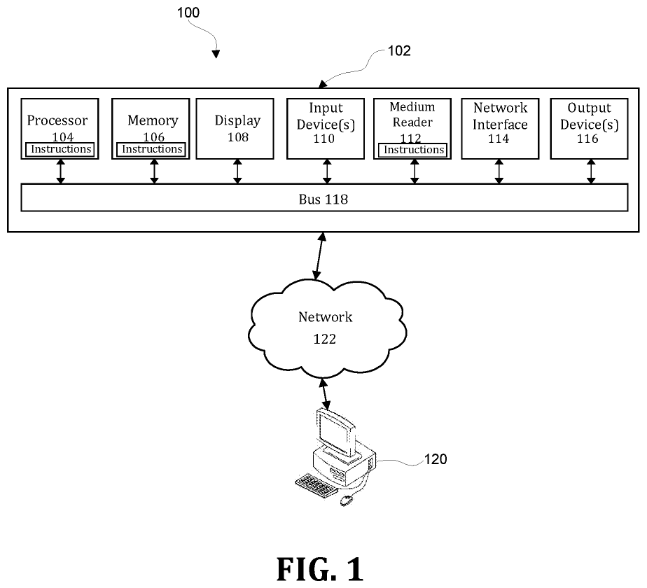

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for generating a counterfactual explanation that is robust with respect to a machine learning model and changes in the model.

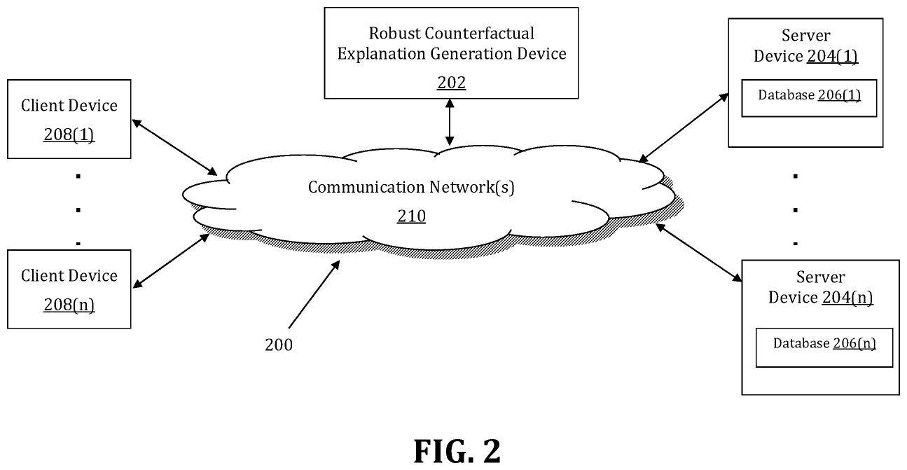

Referring to FIG. 2, a schematic of an exemplary network environment 200 for implementing a method for generating a counterfactual explanation that is robust with respect to a machine learning model and changes in the model is illustrated. In an exemplary embodiment, the method is executable on any networked computer platform, such as, for example, a personal computer (PC).

The method for generating a counterfactual explanation that is robust with respect to a machine learning model and changes in the model may be implemented by a Robust Counterfactual Explanation Generation (RCEG) device 202. The RCEG device 202 may be the same or similar to the computer system 102 as described with respect to FIG. 1. The RCEG device 202 may store one or more applications that can include executable instructions that, when executed by the RCEG device 202, cause the RCEG device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the RCEG device 202 itself, may be located in virtual server(s) running in a cloud-based computing environment rather than being tied to one or more specific physical network computing devices. Also, the application(s) may be running in one or more virtual machines (VMs) executing on the RCEG device 202. Additionally, in one or more embodiments of this technology, virtual machine(s) running on the RCEG device 202 may be managed or supervised by a hypervisor.

In the network environment 200 of FIG. 2, the RCEG device 202 is coupled to a plurality of server devices 204(1)-204(n) that hosts a plurality of databases 206(1)-206(n), and also to a plurality of client devices 208(1)-208(n) via communication network(s) 210. A communication interface of the RCEG device 202, such as the network interface 114 of the computer system 102 of FIG. 1, operatively couples and communicates between the RCEG device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the RCEG device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and RCEG devices that efficiently implement a method for generating a counterfactual explanation that is robust with respect to a machine learning model and changes in the model.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The RCEG device 202 may be a standalone device or integrated with one or more other devices or apparatuses, such as one or more of the server devices 204(1)-204(n), for example. In one particular example, the RCEG device 202 may include or be hosted by one of the server devices 204(1)-204(n), and other arrangements are also possible. Moreover, one or more of the devices of the RCEG device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the RCEG device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information that relates to historical model outputs and information that relates to metrics for model robustness.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the RCEG device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the RCEG device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the RCEG device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the RCEG device 202, the server devices 204(1)-204(n), or the client devices 208(1)-208(n), for example, may be configured to operate as virtual instances on the same physical machine. In other words, one or more of the RCEG device 202, the server devices 204(1)-204(n), or the client devices 208(1)-208(n) may operate on the same physical device rather than as separate devices communicating through communication network(s) 210. Additionally, there may be more or fewer RCEG devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

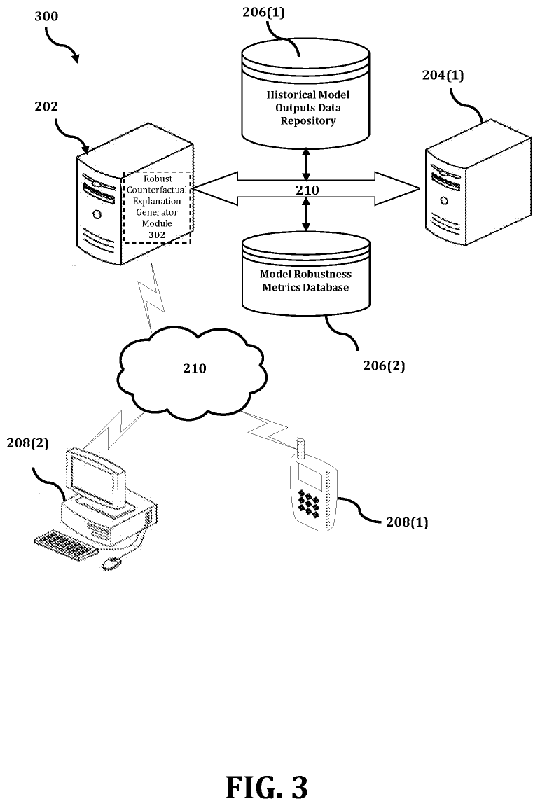

The RCEG device 202 is described and illustrated in FIG. 3 as including a robust counterfactual explanation generator module 302, although it may include other rules, policies, modules, databases, or applications, for example. As will be described below, the robust counterfactual explanation generator module 302 is configured to implement a method for generating a counterfactual explanation that is robust with respect to a machine learning model and changes in the model.

An exemplary process 300 for implementing a mechanism for generating a counterfactual explanation that is robust with respect to a machine learning model and changes in the model by utilizing the network environment of FIG. 2 is illustrated as being executed in FIG. 3. Specifically, a first client device 208(1) and a second client device 208(2) are illustrated as being in communication with RCEG device 202. In this regard, the first client device 208(1) and the second client device 208(2) may be “clients” of the RCEG device 202 and are described herein as such. Nevertheless, it is to be known and understood that the first client device 208(1) and/or the second client device 208(2) need not necessarily be “clients” of the RCEG device 202, or any entity described in association therewith herein. Any additional or alternative relationship may exist between either or both of the first client device 208(1) and the second client device 208(2) and the RCEG device 202, or no relationship may exist.

Further, RCEG device 202 is illustrated as being able to access a historical model outputs data repository 206(1) and a model robustness metrics database 206(2). The robust counterfactual explanation generator module 302 may be configured to access these databases for implementing a method for generating a counterfactual explanation that is robust with respect to a machine learning model and changes in the model.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the RCEG device 202 via broadband or cellular communication. Of course, these embodiments are merely exemplary and are not limiting or exhaustive.

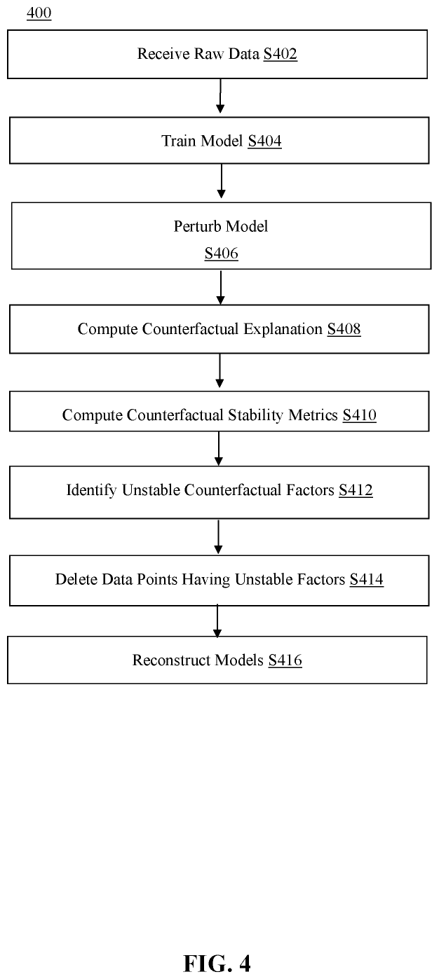

Upon being started, the robust counterfactual explanation generator module 302 executes a process for generating a counterfactual explanation that is robust with respect to a machine learning model and changes in the model. An exemplary process for generating a counterfactual explanation that is robust with respect to a machine learning model and changes in the model is generally indicated at flowchart 400 in FIG. 4.

In process 400 of FIG. 4, at step S402, the robust counterfactual explanation generator module 302 receives at least one set of raw data that relates to a quantity that varies with respect to time and is related to a machine learning model that is configured to project future values of the quantity. In an exemplary embodiment, the model may be configured to project bond pricing values for a particular type of financial bond, and the raw data may include a set of bond pricing values that occurred during a particular time interval. For example, a first set of raw data may include bond pricing data from January 2020 that is deemed as being “pre-COVID-19 pandemic” bond pricing data, and a second set of raw data may include bond pricing data from Autumn 2022 that is deemed as coinciding with a “USA Bear Market.”

At step S404, the robust counterfactual explanation generator module 302 trains the machine learning model by using the raw data received in step S402. In an exemplary embodiment, the model may include any one or more of a tree-based model, a neural network model, and/or a linear model. In an exemplary embodiment, the model may be trained separately for each set of raw data that is provided as an input in step S402.

At step S406, the robust counterfactual explanation generator module 302 perturbs the original version of the model by modifying the raw data in order to generate a perturbed version of the model. In an exemplary embodiment, the perturbation of the model includes any one or more of introducing at least one additional data point to the set of raw data, deleting at least one data point from the set of raw data, averaging data points from within a subset of the raw data, and/or weighting one or more data points from among the raw data.

At step S408, the robust counterfactual explanation generator module 302 computes a first counterfactual explanation with respect to the model. In an exemplary embodiment, the counterfactual explanation includes an identification of features of the model for which a change in the feature would cause a prediction made by the model to change, and the counterfactual explanation further includes a corresponding value for each such feature.

At step S410, the robust counterfactual explanation generator module 302 computes a counterfactual stability metric for each of the original version of the model and the perturbed version of the model. In an exemplary embodiment, the respective counterfactual stability metric is computed by calculating a difference between a mean value of output values of the corresponding version of the model for a predetermined subset of the raw data and a standard deviation of those same output values.

At step S412, the robust counterfactual explanation generator module 302 identifies one or more unstable counterfactual factors. In an exemplary embodiment, the identification of unstable counterfactual factors is performed by identifying a factor for which an output of the original version of the model corresponds to a first prediction and an output of the perturbed version of the model corresponds to a second prediction that is different from the first prediction.

At step S414, the robust counterfactual explanation generator module 302 deletes data points that include any of the unstable counterfactual factors identified in step S412 from each version of the model. Then, at step S416, the robust counterfactual explanation generator module 302 reconstructs both versions of the model based on the remaining data points. In this aspect, the fact that the construction of the models is based on data points that do not include unstable counterfactual factors has the effect of engendering counterfactual explanations that are more robust and thereby less susceptible to minor changes or perturbations.

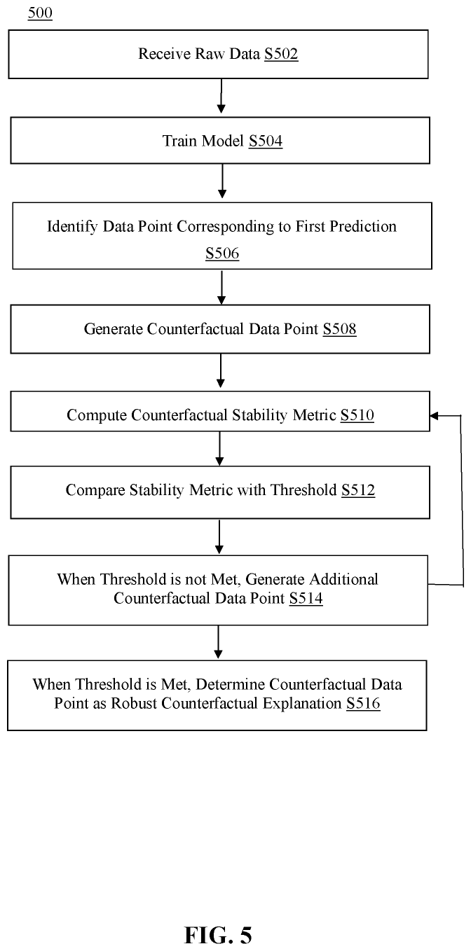

In another exemplary embodiment, the robust counterfactual explanation generator module 302 executes a process for generating a counterfactual explanation that is robust with respect to a predictive machine learning model and changes in the model. A second exemplary process for generating a counterfactual explanation that is robust with respect to a predictive machine learning model and changes in the model is generally indicated at flowchart 500 in FIG. 5.

In process 500 of FIG. 5, all outputs of the predictive model fall in a range of between 0.0 and 1.0, and the predictive model is configured to make one of two possible predictions, including a first prediction which is made whenever the model output is greater than or equal to 0.0 and less than or equal to 0.5, and also including a second prediction which is made whenever the model output is greater than 0.5 and less than or equal to 1.0.

At step S502, the robust counterfactual explanation generator module 302 receives at least one set of raw data that relates to a quantity that varies with respect to time and is related to a predictive machine learning model that is configured to project future values of the quantity. In an exemplary embodiment, the model may be configured to project bond pricing values for a particular type of financial bond, and the raw data may include a set of bond pricing values that occurred during a particular time interval. For example, a first set of raw data may include bond pricing data from January 2020 that is deemed as being “pre-COVID-19 pandemic” bond pricing data, and a second set of raw data may include bond pricing data from Autumn 2022 that is deemed as coinciding with a “USA Bear Market.” In another exemplary embodiment, the model may be configured to make a credit scoring decision that corresponds to either accepting or rejecting a particular request for credit to be used for executing a transaction.

At step S504, the robust counterfactual explanation generator module 302 trains the machine learning model by using the raw data received in step S502. In an exemplary embodiment, the model may include any one or more of a tree-based model, a neural network model, and/or a linear model. In an exemplary embodiment, the model may be trained separately for each set of raw data that is provided as an input in step S502.

At step S506, the robust counterfactual explanation generator module 302 identifies a first data point for which the output of the model is between 0.0 and 0.5 and the first prediction is made. Then, at step S508, the robust counterfactual explanation generator module 302 generates a first counterfactual data point such that the output of the model is between 0.5 and 1.0 and the second prediction is made.

At step S510, the robust counterfactual explanation generator module 302 determines a value of a counterfactual stability metric with respect to the first counterfactual data point. In an exemplary embodiment, the counterfactual stability metric is computed by calculating a difference between a mean value of output values of the model for a subset of the raw data that is selected based on proximity to the first counterfactual data point and a standard deviation of those same output values.

At step S512, the robust counterfactual explanation generator module 302 compares the counterfactual stability metric as determined in step S510 with a predetermined threshold value. In an exemplary embodiment, the threshold is chosen so as to distinguish between relatively robust counterfactuals and relatively non-robust counterfactuals. Thus, at step S514, when the threshold is not met, the robust counterfactual explanation generator module 302 returns to step S508 in order to generate a new counterfactual data point, which is then subjected to the same robustness test by repeating steps S510 and S512. Conversely, when the threshold is met, then at step S516, the counterfactual data point that has passed the test by having a counterfactual stability metric that meets or exceeds the threshold is thus determined as being a robust counterfactual explanation.

Counterfactual explanations inform ways to achieve a desired outcome from a machine learning model. However, such explanations are not necessarily robust with respect to certain real-world changes in the underlying model, such as, for example, retraining the model or changing hyperparameters. Any such lack of robustness leads to questions regarding their reliability in several applications, e.g., credit lending. In an exemplary embodiment, the present inventive concept provides a novel strategy for generating robust counterfactuals for tree-based ensembles. Tree-based ensembles pose additional challenges in robust counterfactual generation, because they have a non-smooth and non-differentiable objective function, and they may be highly variable in the parameter space under retraining on very similar data. In an exemplary embodiment, the methodology makes use of a counterfactual stability metric that attempts to quantify how robust a counterfactual is going to be with respect to model changes under retraining, and also has desirable theoretical properties. This methodology works with any counterfactual generation base method and searches for robust counterfactuals by iteratively refining the counterfactual generated by the base method using our counterfactual stability metric.

Quantification of Counterfactual Stability: In an exemplary embodiment, the counterfactual stability metric quantifies how robust a counterfactual is going to be to possible changes in the model. In order to arrive at this metric, an identification is made of the desirable theoretical properties of counterfactuals in tree-based ensembles that can make them more stable, i.e., less likely to be invalidated due to possible model changes under retraining. Tree-based ensembles pose additional challenges in robust counterfactual generation because they do not conform to standard assumptions, e.g., they are not smooth and continuous, have a non-differentiable objective function, and may vary widely in the parameter space under retraining on similar data. In an exemplary embodiment, the proposed quantification is of the form R_{Φ}(x, M) where x∈R^{d} is an input (not necessarily in the dataset or data manifold), M(⋅):R^{d}→[0, 1] is the original model, and Φ denotes some hyperparameters for this metric. A determination has been made that while counterfactuals on the data manifold have been found to be more robust than simply “closest” or “sparsest” counterfactuals, being on the data manifold may not be sufficient for robustness, thus calling for this counterfactual stability metric.

Conservative Counterfactuals With Theoretical Robustness Guarantee: In an exemplary embodiment, the concept of “conservative counterfactuals” refers to counterfactuals, i.e., points with desired outcome, lying in the dataset that also have high counterfactual stability R_{Φ}(x, M). Given an input x∈R^{d}, a conservative counterfactual is essentially its nearest neighbor in the dataset on the other side of the decision boundary that also passes the counterfactual stability test, i.e., R_{Φ}(x, M)≥τ for some threshold τ. A theoretical guarantee that bounds the probability of invalidation of the conservative counterfactual under model changes is provided.

An Algorithm for Robust Counterfactual Explanations (RobX): In an exemplary embodiment, an algorithm that generates robust counterfactuals for tree-based ensembles leveraging the counterfactual stability metric is provided. The strategy is applicable after generating counterfactuals using any of the existing methods for tree-based ensembles, also referred to herein as base methods. The strategy iteratively refines the counterfactual generated by the base method and moves it towards the conservative counterfactual, until a “stable” counterfactual is found, i.e., one that passes a counterfactual stability test R_{Φ}(x, M)≥τ).

Drastic Model Changes: One might question that why should one want counterfactuals to necessarily remain valid after changes to the model. In this aspect, the question may be framed as whether it would be better for counterfactuals to vary with the model in order to reflect the changes to the model. For example, economic changes might cause drastic changes in lending models, possibly due to major data distribution shifts. In such scenarios, one might in fact prefer counterfactuals for the old and new models to be different. Indeed, it is true that counterfactuals are not required to remain valid for very drastic changes to the model. However, the present disclosure focuses on small changes to the model, such as, for example, retraining on some data drawn from the same distribution, or minor changes to the hyperparameters, thus keeping the underlying data mostly similar. Such small changes to the model are in fact quite common in several applications and occur frequently in practice.

Problem Setup: Let X⊆R_{d} [symbol] denote the input space and let S={xᵢ}^{N}∈X be a dataset consisting of N independent and identically distributed points generated from a density q over X. Further, M(⋅):R^{d}→[0, 1] denotes the original machine learning model, i.e., a tree-based ensemble, that takes an input value and produces an output probability lying between 0.0 and 1.0. The final decision is denoted by: D(x)=1 if M(x)>0.5; D(x)=0 otherwise. Similarly, a changed model is denoted by M_{new}(⋅):R^{d}→[0, 1], and the decision of the changed model by: D_{new}(x)=1 if M_{new}(x)>0.5; D_{new}(x)=0 otherwise.

A tree-based ensemble model is defined as follows: M(x)=Σ^{T}ₜ₌₁m^{(t)}(x) where each m^{(t)}(x) is an independent tree with L leaves, having weights {w₁, . . . , w_{L}}∈R. A tree m^{(t)}(x) maps a data point x∈R^{d} to one of the leaf indices, based on the tree structure, and produces an output wₗ∈{w₁, . . . , w_{L}}. One may use a sigmoid function to ensure that the final output lies within the range [0, 1].

Background on Counterfactuals: Definition 1—Closest Counterfactual Cₚ(x, M)): Given x∈R^{d} such that M(x)≤0.5, its closest counterfactual, in terms of Lₚ-norm, with respect to the model M(⋅) is defined as a point x′∈R^{d} that minimizes the lₚ norm ∥x−x′∥ₚ such that M(x′)>0.5. Definition 1 may also be expressed as follows:

$${C}_{p} ( x , M ) = arg {min}_{{x}^{′} ∈ {R}^{d}} {‖ x - {x}^{′} ‖}_{p} such that M ( {x}^{′} ) > 0.5 .$$

Definition 2—Closest Data-Support Counterfactual C_{p,S}(x, M): Given x∈R^{d} such that M(x)≤0.5, its closest data-support counterfactual C_{p,S}(x, M) with respect to the model M(⋅) and dataset S is defined as a point x′∈S that minimizes the lₚ norm ∥x−x′∥ₚ such that M(x′)>0.5. Definition 2 may also be expressed as follows:

$${C}_{p , S} ( x , M ) = arg {min}_{{x}^{′} ∈ S} {‖ x - {x}^{′} ‖}_{p} such that M ( {x}^{′} ) > 0.5 .$$

Metrics to Quantify Likeness to Data Manifold: In practice, instead of finding counterfactuals that lie exactly on the dataset, one may use alternate metrics that quantify how alike or anomalous is a point with respect to the dataset. One popular metric to quantify anomality on counterfactual explanations is Local Outlier Factor. Definition 3—Local Outlier Factor (LOF): For x∈S, let Nₖ(x) be its k-nearest neighbors (k-NN) in S. The k-reachability distance rdₖ of x with respect to x′ is defined by rdₖ(x, x′)=max{Δ(x, x′), dₖ(x′)}, where dₖ(x′) is the distance Δ between x′ and its the k-th nearest instance on S. The k-local reachability density of x is defined by lrdₖ(x)=|Nₖ(x)|Σ_{x′∈N(x)}rdₖ(x, x′))⁻¹. Then, the k-LOF of x on S is defined as follows:

$${q}_{k} ( x \vert 𝒮 ) = \frac{1}{\vert {N}_{k} ( x ) \vert} {\sum }_{{x}^{′} ∈ {N}_{k} ( x )} \frac{{lrd}_{k} ( {x}^{′} )}{{lrd}_{k} ( x )} .$$

Here, Δ(x, x′) is the distance between two d-dimensional feature vectors.

In an exemplary embodiment, the computation of LOF may be implemented by predicting −1 if the point is anomalous, and +1 for inliers. So, a high average LOF essentially suggests the points lie on the data manifold, and are more realistic, i.e., higher is better.

Goals: Given a data point x∈X such that M(x)≤0.5, a goal is to find a counterfactual x′ with M(x′)>0.5 that meets the following requirements: 1) Close in terms of Lₚ cost: The point x′ is close to x, i.e., ∥x−x′∥ is as low as possible. 2) Robust: The point x′ remains valid after changes to the model, i.e., M_{new}(x′)>0.5. 3) Realistic: The point x′ is as similar to the data manifold as possible, e.g., has a high LOF (higher is better). Bookkeeping Past Counterfactuals: One possible solution for ensuring the robustness of counterfactuals under model changes could be to keep a record of past counterfactuals. Then, even if there are small changes to the model that can render those counterfactuals invalid, one might still want to accept them because they have been recommended in the past: Output D(x) if x is a past counterfactual or D_{new}(x) otherwise. However, this approach would require significant storage overhead. Furthermore, there would also be fairness concerns if two data points that are extremely close to each other are receiving the same decision, e.g., one is being accepted because it was a past counterfactual even though the new model rejects it, while the other point is being rejected.

Main Results: In an exemplary embodiment, the desirable properties of counterfactuals in tree-based ensembles that make them more stable, i.e., less likely to be invalidated by small changes to the model, are identified. These properties give rise to a novel metric, i.e., a counterfactual stability metric, that quantifies the robustness of a counterfactual with respect to possible changes to a model. This metric guides one to arrive at an algorithm for generating robust counterfactuals that can be applied over any base method.

Desirable properties of counterfactuals in tree-based ensembles that make them more stable: In an exemplary embodiment, it is desirable to find counterfactuals that are robust with respect to small changes to the model, e.g., retraining on some data from the same distribution, or minor changes to the hyperparameters. It is noted that if the model changes drastically, it might not make sense to expect that counterfactuals will remain valid, as demonstrated in the following impossibility result.

Theorem 1—Impossibility Under Drastic Model Changes: Given a tree-based ensemble model M(⋅):R^{d}→[0, 1], there always exists another tree-based ensemble model M_{new}(⋅):R^{d}→[0, 1] such that all counterfactuals to M with respect to a dataset S no longer remain valid.

Thus, there is an initial need to make some reasonable assumptions on how the model changes during retraining, or rather, what kind of model changes are of most interest.

In an exemplary embodiment, the following desirable properties of counterfactuals for tree-based ensembles that can make them more stable, i.e., less likely to be invalidated are determined. The first property is based on the fact that the output of a model M(x)∈[0, 1] is expected to be higher if the model has more confidence in that prediction. Property 1: For any x∈R^{d}, a higher value of M(x) makes it less likely to be invalidated due to model changes.

However, having a relatively high M(x) may not be the only property to ensure robustness, particularly in tree-based ensembles. This is because tree-based models do not have a smooth and continuous output function. For instance, there may exist points x∈R^{d} with very high output values M(x) but several points in its neighborhood have a low output value (i.e., not smooth). There may be points with high M(x) that are quite close to the decision boundary, and thus more vulnerable to being invalidated with model changes.

As a safeguard against such a possibility, the next desirable property is introduced. Property 2: An x∈R^{d} is less likely to be invalidated due to model changes if several points close to x, denoted by x′, have a high value of M(x′).

It is also noted that a counterfactual may be more likely to be invalidated if it lies in a highly variable region of the model output function M(x). This is because the confidence of the model predictions in that region might be less reliable. One resolution to capturing the variability of a model output is to examine its derivative. However, because tree-based ensembles are not differentiable, the standard deviation of the model output around x is examined as a representative of its variability.

Property 3: An x∈R^{d} is less likely to be invalidated due to model changes if the model output values around x have low variability, i.e., standard deviation.

Proposed Quantification of Robustness to Possible Model Changes: Counterfactual Stability: These properties lead to a counterfactual stability metric that attempts to quantify the robustness of a counterfactual x∈R^{d} to possible changes in the model (irrespective of whether x is in the data manifold).

Definition 4—Counterfactual Stability: The stability of a counterfactual x∈R^{d} is defined as follows:

$${R}_{K , {σ}^{2}} ( x , M ) = \frac{1}{K} {\sum }_{{x}^{′} ∈ {N}_{x}} M ( {x}^{′} ) - \sqrt{\frac{1}{K} {\sum }_{{x}^{′} ∈ {N}_{x}} {( M ( {x}^{′} ) - \frac{1}{K} {\sum }_{{x}^{′} ∈ {N}_{x}} M ( {x}^{′} ) )}^{2}}$$

where Nₓ, is a set of K points in R^{d} drawn from the distribution N (x, σ²I_{d}) where I_{d} is the identity matrix.

This metric of counterfactual stability is

$${aligned with}_{\begin{matrix}K & x ∈ {N}_{x}\end{matrix}} desirable properties .$$

Given a point x∈R^{d}, the metric generates a set of K points centered around x. The first term 1/KΣ_{x′∈N}_{ₓ}M(x′) is expected to be high if the model output value M(x) is high for x (i.e., Property 1) as well as several points close to x (Property 2). However, it is noted that the mean value of M(x) around a point x∈R^{d} may not always capture the variability in that region. For instance, a combination of very high and very low values can also produce a reasonable mean value. Thus, a second term is also incorporated, i.e., the standard deviation

$$\sqrt{\frac{1}{K} {\sum }_{{x}^{′} ∈ {N}_{x}} {( M ( {x}^{′} ) - \frac{1}{K} {\sum }_{{x}^{′} ∈ {N}_{x}} M ( {x}^{′} ) )}^{2}} ,$$

which captures the variability of the model output values in a region around x (recall Property 3). It is also noted that the variability term (i.e., standard deviation) in Definition 4 is useful only given the first term mean) as well. This is because even points on the other side of the decision boundary, i.e., M(x′)<0.5, can have high or low variance.

Next, a description of how the proposed metric can be used to test whether a counterfactual is stable is provided. Definition 5—Counterfactual Stability Test: A counterfactual x∈R^{d} satisfies the counterfactual stability test if R_{K,σ}2(x, M)≥τ.

Data Manifold: The definition of counterfactual stability holds for all points x∈R^{d} and is not necessarily restricted to points that lie on the data manifold, e.g., x∈S. This is because there might be points or regions outside the data manifold that could also be robust to model changes. For example, assume a loan applicant who is exceptionally good at literally everything. Such an applicant might not lie on the data manifold, but it is expected that most models would accept such a data point even after retraining.

Concept of Conservative Counterfactuals: This concept allows for use of the counterfactual stability test to generate stable counterfactuals from the dataset. Definition 6—Conservative Counterfactual C^{(τ)} (x, M): Given a data point x∈S such that M(x)≤0.5, a conservative counterfactual C^{(τ)} (x, M) is defined as a data point x∈S such that M(x′)>0.5 and R_{K,σ}2(x′, M)≥τ, that also minimizes the lₚ norm ∥x−x′∥ₚ, i.e.,

$${𝒞}_{p , 𝒮}^{( τ )} ( x , M ) = arg {min}_{{x}^{′} ∈ 𝒮} {‖ x - {x}^{′} ‖}_{p} \\ such that M ( {x}^{′} ) > 0.5 and {R}_{K , {σ}^{2}} ( {x}^{′} , M ) \geq τ .$$

Existence: Higher τ leads to better robustness. However, a conservative counterfactual may or may not exist depending on how high the threshold τ is. When τ is very low, the conservative counterfactuals become the closest data-support counterfactuals.

Theoretical Robustness Guarantee of Conservative Counterfactuals: Two assumptions over the randomness of the new model M_{new} are introduced. Assumption 1—Goodness of Metric: For any data point x∈R^{d}, let M_{new}(x) be a random variable taking different values due to model changes. It is assumed that the expected value E[M_{new}(x)]>R_{K,σ}2(x, M). Assumption 2—Goodness of Data Manifold: The standard deviation of M_{new}(x) is Vₓ which depends on x. When x∈S, then Vₓ≤V for a small constant V.

The rationale for Assumption 2 is built on evidence that demonstrates that data-support counterfactuals are more robust than closest or sparsest counterfactuals. When a model is retrained on same or similar data, the decisions of a model are less likely to change for points that lie on the data manifold as compared to points that may not lie on the data manifold.

One-Way Implication: While it is assumed that the new model outputs for points in the dataset S have low standard deviation, it is not necessarily assumed that points outside the dataset S would always have high standard deviation. This is because there can potentially be regions outside the data manifold that also have low Vₓ, and are also robust to model changes.

One popular assumption to quantify small model changes is to assume that the model changes are bounded in the parameter space, i.e., |Parameters(M)−Parameters(M_{new})|≤Δ, where Parameters(M) denote the parameters of the model M, e.g., weights of a neural network. However, this might not be a good assumption for tree-based ensembles. This is because tree-based ensembles may often vary widely a lot in the parameter space while actually causing very little difference with respect to the actual decisions on the dataset S.

Closely connected to model change is the idea of Rashomon models, which suggests that there can be models that are very different from each other but have almost similar performance on the same data, e.g., _{x∈S}|D(x)−D_{new}(x)|≤Δ. Thus, Assumption 2 might be better suited for tree-based ensembles over boundedness in the parameter space.

The following is the main result of the above, which is a robustness guarantee on conservative counterfactuals based on these assumptions. Theorem 2—Robustness Guarantee for Conservative Counterfactuals: Suppose Assumptions 1 and 2 hold, and τ>0.5. Then, for any conservative counterfactual x′∈C^{(τ)} (x, M), the following holds:

$$Pr ( {M}_{new} ( {x}^{′} ) < 0.5 ) \leq \frac{{V}^{2}}{{V}^{2} + {( τ - 0.5 )}^{2}}$$

The above result essentially says that the probability of invalidation by the new model (Pr(M_{new}(x′)<0.5)) is strictly upper-bounded for conservative counterfactuals. A smaller variability V makes this bound smaller.

The conservative counterfactuals, hereinafter also referred to by “CCF,” already serve as good candidates for robust counterfactuals. They are also expected to be realistic with high LOF because they lie in the dataset S. However, because they only search for counterfactuals on the dataset S, they may not always be optimal in terms of the distance between the original data point and its counterfactual, i.e., not so close. This leads us to a novel algorithm that leverages conservative counterfactuals (CCF) and counterfactual stability test to find robust counterfactuals that meet all of the requirements of closeness, robustness, and being realistic.

Proposed Algorithm to Generate Robust Counterfactuals in Practice - Algorithm
1: Generating Robust Counterfactual Explanations for Tree-Based Ensembles.

```
Input: Model M(·), Dataset S, Datapoint x such that M(x) ≤ 0.5, Algorithm parameters (p,
K, σ², τ, α, c)
Step 1: Generate counterfactual x′ for x using any existing technique for tree-based
ensembles
Step 2: Perform counterfactual stability test on x′: Check if R_{K,σ}_{²}(x′, M) ≥ τ where Nₓ
is a set of K points drawn from the distribution N(x, σ²).
If: Counterfactual stability test is satisfied:
Then: Output x′ and exit
Else:
Generate c conservative counterfactuals {x₁, . . . , x_{c}} which are c nearest neighbors of x′ in
the dataset S that pass the stability test: R_{K,σ}2 (xᵢ, M) ≥ τ
Initialize placeholders for c counterfactuals {x′ , . . . , x′} with each x′ = x′
For i = 1 to c do
repeat
  Update: x′ᵢ = axᵢ + (1 − α)x′ᵢ
  Perform counterfactual stability test on x′ᵢ:
    R_{K,σ}2 (xᵢ', M) ≥ τ
  until counterfactual stability test on xᵢ′ is satisfied
End For
End If
Output x* = arg min _{x′ ϵ(x′,x′,...,x′}} ||x - x′||ₚ and exit
```

In an exemplary embodiment, algorithm 1 can be applied on top of any preferred base method of counterfactual generation, irrespective of whether the counterfactual lies in the dataset S. The algorithm checks if the generated counterfactual satisfies the counterfactual stability test: if the test is not satisfied, the algorithm iteratively refines the obtained counterfactual and keeps moving it towards the conservative counterfactual until a stable counterfactual is found that satisfies the test.

One might wonder if moving a counterfactual towards the conservative counterfactual can cause it to pass through undesired regions of the model output where M(x)<0.5, thus making it more vulnerable to invalidation. In this aspect, it is noted that while this concern is reasonable, the counterfactual stability test at each step ensures that such points are not selected. This concern is further addressed as follows: 1) consider a diverse set of conservative counterfactuals, such as, for example, the first c nearest neighbors that satisfy the stability test where c>1); 2) iteratively move towards each one of them until a stable counterfactual is found for all c cases; (3) pick the best of these c stable counterfactuals, e.g., one with the lowest L₁ or L₂ cost as desired.

It is also observed that this approach of moving a counterfactual towards a conservative counterfactual improves its LOF, making it more realistic.

Accordingly, with this technology, an optimized process for generating a counterfactual explanation that is robust with respect to a machine learning model and changes in the model is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for generating a counterfactual explanation with respect to a machine learning model, the method being implemented by at least one processor, the method comprising:
receiving, by the at least one processor, a first set of raw data that is usable for training an original version of a first model;
training, by the at least one processor, the original version of the first model by using the first set of raw data;
perturbing, by the at least one processor, the first model by modifying the first set of raw data, in order to generate a perturbed version of the first model;
computing, by the at least one processor, a first counterfactual explanation that relates to the first model;
computing, by the at least one processor, a first counterfactual stability metric that relates to the original version of the first model and a second counterfactual stability metric that relates to the perturbed version of the first model;
identifying, by the at least one processor, at least one unstable counterfactual factor that relates to at least one from among the original version of the first model and the perturbed version of the first model;
deleting, by the at least one processor, data points that include the at least one unstable counterfactual factor from each of the original version of the first model and the perturbed version of the first model; and
reconstructing each of the original version of the first model and the perturbed version of the first model based on data that does not include the deleted data points.

2. The method of claim 1, wherein the perturbing of the first model comprises at least one from among introducing at least one additional data point to the first set of raw data, deleting at least one data point from the first set of raw data, averaging a plurality of data points of a subset of the first set of raw data, and weighting at least one data point from the first set of raw data.

3. The method of claim 1, wherein the first counterfactual explanation comprises a first plurality of features that relate to the first model and, for each respective feature from among the first plurality of features, a corresponding value.

4. The method of claim 1, wherein the computing of the first counterfactual stability metric comprises calculating a difference between a mean value of output values of the original version of the first model for a predetermined subset of the first set of raw data and a standard deviation of the output values of the original version of the first model for the predetermined subset of the first set of raw data.

5. The method of claim 1, wherein the computing of the second counterfactual stability metric comprises calculating a difference between a mean value of output values of the perturbed version of the first model for a predetermined subset of the first set of raw data and a standard deviation of the output values of the perturbed version of the first model for the predetermined subset of the first set of raw data.

6. The method of claim 1, wherein the identifying of the at least one unstable counterfactual factor comprises identifying a counterfactual factor for which an output of the original version of the first model corresponds to a first prediction and an output of the perturbed version of the first model corresponds to a second prediction that is different from the first prediction.

7. The method of claim 1, wherein the first model includes at least one from among a tree-based model, a neural network model, and a linear model.

8. The method of claim 1, wherein the first set of raw data comprises bond pricing data that relates to a first bond, and wherein the first model is configured to generate a projected price of the first bond at a particular time.

9. A computing apparatus for generating a counterfactual explanation with respect to a machine learning model, the computing apparatus comprising:
a processor;
a memory; and
a communication interface coupled to each of the processor and the memory,
wherein the processor is configured to:
receive, via the communication interface, a first set of raw data that is usable for training an original version of a first model;
train the original version of the first model by using the first set of raw data;
perturb the first model by modifying the first set of raw data, in order to generate a perturbed version of the first model;
compute a first counterfactual explanation that relates to the first model;
compute a first counterfactual stability metric that relates to the original version of the first model and a second counterfactual stability metric that relates to the perturbed version of the first model;
identify at least one unstable counterfactual factor that relates to at least one from among the original version of the first model and the perturbed version of the first model;
delete data points that include the at least one unstable counterfactual factor from each of the original version of the first model and the perturbed version of the first model; and
reconstruct each of the original version of the first model and the perturbed version of the first model based on data that does not include the deleted data points.

10. The computing apparatus of claim 9, wherein the processor is further configured to perturb the first model by at least one from among introducing at least one additional data point to the first set of raw data, deleting at least one data point from the first set of raw data, averaging a plurality of data points of a subset of the first set of raw data, and weighting at least one data point from the first set of raw data.

11. The computing apparatus of claim 9, wherein the first counterfactual explanation comprises a first plurality of features that relate to the first model and, for each respective feature from among the first plurality of features, a corresponding value.

12. The computing apparatus of claim 9, wherein the processor is further configured to compute the first counterfactual stability metric by calculating a difference between a mean value of output values of the first model for a predetermined subset of the first set of raw data and a standard deviation of the output values of the first model for the predetermined subset of the first set of raw data.

13. The computing apparatus of claim 9, wherein the processor is further configured to compute the second counterfactual stability metric by calculating a difference between a mean value of output values of the perturbed version of the first model for a predetermined subset of the first set of raw data and a standard deviation of the output values of the perturbed version of the first model for the predetermined subset of the first set of raw data.

14. The computing apparatus of claim 9, wherein the processor is further configured to identify the at least one unstable counterfactual factor by identifying a counterfactual factor for which an output of the original version of the first model corresponds to a first prediction and an output of the perturbed version of the first model corresponds to a second prediction that is different from the first prediction.

15. The computing apparatus of claim 9, wherein the first model includes at least one from among a tree-based model, a neural network model, and a linear model.

16. The computing apparatus of claim 9, wherein the first set of raw data comprises bond pricing data that relates to a first bond, and wherein the first model is configured to generate a projected price of the first bond at a particular time.

17. A non-transitory computer readable storage medium storing instructions for generating a counterfactual explanation with respect to a machine learning model, the storage medium comprising executable code which, when executed by a processor, causes the processor to:
receive a first set of raw data that is usable for training an original version of a first model;
train the original version of the first model by using the first set of raw data;
perturb the first model by modifying the first set of raw data, in order to generate a perturbed version of the first model;
compute a first counterfactual explanation that relates to the first model;
compute a first counterfactual stability metric that relates to the original version of the first model and a second counterfactual stability metric that relates to the perturbed version of the first model;
identify at least one unstable counterfactual factor that relates to at least one from among the original version of the first model and the perturbed version of the first model;
delete data points that include the at least one unstable counterfactual factor from each of the original version of the first model and the perturbed version of the first model; and
reconstruct each of the original version of the first model and the perturbed version of the first model based on data that does not include the deleted data points.

18. The storage medium of claim 17, wherein when executed by the processor, the executable code further causes the processor to perturb the first model by at least one from among introducing at least one additional data point to the first set of raw data, deleting at least one data point from the first set of raw data, averaging a plurality of data points of a subset of the first set of raw data, and weighting at least one data point from the first set of raw data.

19. A method for generating a counterfactual explanation with respect to a first predictive machine learning (ML) model for which all outputs fall in a range of between 0.0 and 1.0 such that when an output is between 0.0 and 0.5, a first prediction is made and when the output is between 0.5 and 1.0, a second prediction is made, the method being implemented by at least one processor, the method comprising:
receiving, by the at least one processor, a first set of raw data that is usable for training the first predictive ML model;
training, by the at least one processor, the first predictive ML model by using the first set of raw data;
identifying a first data point for which the output of the first predictive ML model is between 0.0 and 0.5 and the first prediction is made;
generating a first counterfactual data point such that the output of the first predictive ML model is between 0.5 and 1.0 and the second prediction is made;
determining a value of a counterfactual stability metric with respect to the first counterfactual data point;
comparing the value of the counterfactual stability metric with a predetermined threshold;
when the value of the counterfactual stability metric is greater than or equal to the predetermined threshold, determining the first counterfactual data point as being a robust counterfactual explanation with respect to the first predictive ML model; and
when the value of the counterfactual stability metric is less than the predetermined threshold, generating a set of conservative counterfactual data points that are included in the first set of raw data for which a corresponding value of the counterfactual stability metric is greater than the predetermined threshold, and using the set of conservative counterfactual data points to generate a second counterfactual data point for which a corresponding value of the counterfactual stability metric is greater than or equal to the predetermined threshold.

20. The method of claim 19, wherein the computing of the counterfactual stability metric comprises calculating a difference between a mean value of output values of the first model for a predetermined subset of the first set of raw data and a standard deviation of the output values of the first model for the predetermined subset of the first set of raw data.
